(19) United States
(12) Patent Application Publication
(10) Pub. No.: US 2009/0289947 A1
(43) Pub. Date: Nov. 26, 2009

(54) SYSTEM AND METHOD FOR PROCESSING DATA SENT FROM A GRAPHIC ENGINE

(75) Inventor: Mu-Hsien Hsu, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX TECHNOLOGIES LIMITED, Tainan County (TW)

(21) Appl. No.: 12/123,526

(22) Filed: May 20, 2008

(51) Int. Cl. G09G 5/399; G09G 5/36

(52) U.S. Cl. 345/539; 345/545

(57) ABSTRACT

An image processing system is provided comprising a memory, a graphic engine and a data processing module. The graphic engine generates a sequence of input data, wherein each of the input data has an address information pointing to a corresponding memory address of the memory. The data processing module sequentially receives the input data from the graphic engine, buffers each of the received data into a corresponding buffer according to the address information thereof, and outputs buffered data in a buffer to the memory when the buffer is full, wherein memory addresses of the outputted data are continuous.

### BACKGROUND OF THE INVENTION

1. Field of the Invention

The invention relates to a system and method for image data processing, and more particularly to a system and method for processing image data sent from a graphic engine of an image processing system.

2. Description of the Related Art

As the demand for better graphics increase, graphic engines or graphic accelerators are widely used in image processing systems for displaying image data, which can include still images and/or video (moving image) data. In the image processing system, a graphic engine executes a drawing process upon a memory known as frame buffer in accordance with drawing commands or parameters transferred from a central processing unit (CPU).

However, in such an image data processing system with a graphic engine, memory access of the graphic engine is usually a single transfer access since the data type, such as memory address, sent by the graphic engine is frequently discontinuous. For example, in the straight line drawing of an arbitrary direction or a curve drawing, the memory addresses are not in the same continuous row address such that; a single transfer access is accomplished, thus, making memory utility not very efficient. It is therefore desired, to have a system and method for processing image data sent from a graphic engine which improves memory utility.

### BRIEF SUMMARY OF THE INVENTION

An image processing system is provided comprising a memory, a graphic engine and a data processing module. The graphic engine generates a sequence of input data, wherein each of the input data has an address information pointing to a corresponding memory address of the memory. The data processing module sequentially receives the input data from the graphic engine, buffers each of the received data into a corresponding buffer according to the address information thereof, and outputs buffered data in a buffer to the memory when the buffer is full, wherein memory addresses of the outputted data are continuous.

A data processing method for use in an image processing system is provided. The method comprises the following steps. First, data from a graphic engine are sequentially received, each of which has an address information pointing to a corresponding memory address of a memory. Each of the received data is buffered into a corresponding buffer according to the address information thereof. Next, buffered data in a buffer is outputted to the memory when the buffer is full, wherein memory addresses of the outputted data are continuous.

A data processing method for use in an image processing system is further provided. The image processing system comprises a graphic engine, a plurality of buffers and a memory. First, data from the graphic engine are sequentially received, each of which has an address information pointing to a corresponding memory address of the memory. Each of the received data is buffered into a corresponding buffer according to the address information thereof. The address information of currently received data is compared with that of previously buffered data and the currently received data is buffered in a buffer of the buffered data, wherein the memory address is adjacent to that of the currently received data. Data buffered in a buffer is outputted to the memory when the buffer is full. Data buffered in other buffers other than the completely filled buffer are then outputted to the memory after the data transfer has been completed, wherein memory addresses of the outputted data are continuous.

### BRIEF DESCRIPTION OF THE DRAWINGS

The invention can be more fully understood by reading the subsequent detailed description and examples with references made to the accompanying drawings, wherein:

FIG. 1 shows an embodiment of an image processing system;

FIG. 2 shows an embodiment of the input data;

FIGS. 3A and 3B show a flowchart of a method for processing data in an image processing system according to the invention; and

FIG. 4 is a schematic showing an embodiment of the method of FIG. 3 according to the invention.

### DETAILED DESCRIPTION OF THE INVENTION

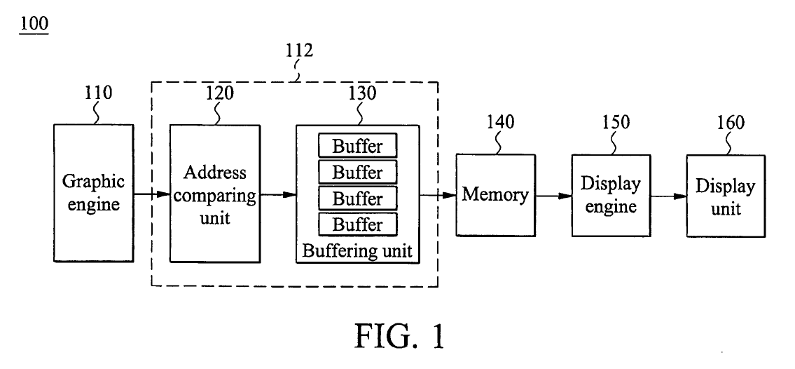

FIG. 1 shows an embodiment of an image processing system 100. As shown in FIG. 1, the image processing system 100 at least comprises a graphic engine 110, a data processing module 112, a memory 140 (typically referred to as frame buffer), a display engine 150 and a display unit 160. The graphic engine 110 may receive commands or parameters transferred from a central processing unit (not shown) and then send corresponding input data which is to be written/stored into the memory 140. The data processing module 112 sequentially receives the input data from the graphic engine 110, buffers each of the received data into a corresponding buffer according to the address information thereof, and outputs buffered data in a buffer to the memory 140 when the buffer is full. The memory 140 stores data to be displayed on the display unit 160. The input data may be, for example, an image data for displaying an image or picture or an on-screen display (OSD) data. The OSD data may relate to setup information, programming information, menu information, user messages, and/or other information that may be displayed on the display unit 160, independent of the image data that is displayed thereon.

The data processing module 112 further comprises an address comparing unit 120 such as an address comparison logic and a buffering unit 130. The buffering unit 130 has a plurality of buffers. It is to be noted that the buffering unit 130 may comprise any storable elements capable of temporarily storing the received data, such as a first-in-first-out (FIFO) buffer, and the length (i.e. buffer capacity) and number of buffers used in the buffering unit 130 can be determined in advance based on the system or user requirements.

The data sent by the graphic engine 110 is then fed to the address comparing unit 120 of the data processing module 112. Each fed data may comprise a portion of address information and a portion of actual data value in which the address information points to a corresponding memory address of the memory 140 to store it.

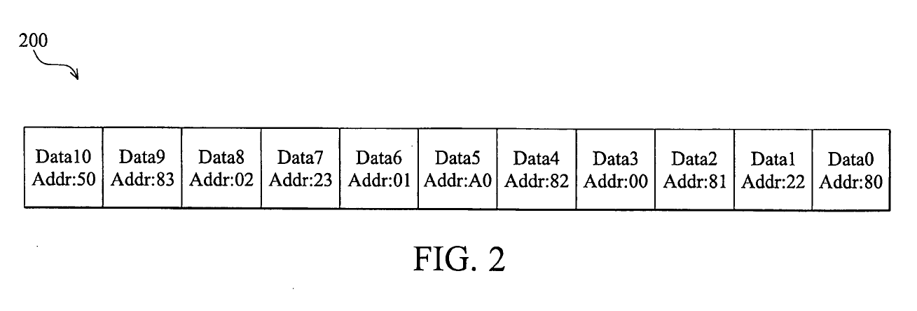

FIG. 2 shows an embodiment of the input data. As shown in FIG. 2, each of input data Data0-Data10 has a data value DataX (e.g, a pixel value with 24 bits in format of R, G, B) and an address information Addr which points to the corresponding memory address storing the data value. For example, the address information Addr for the input data Data0 and Data1 are 80 and 22 respectively, thus the input data Data0 and Data1 are to be stored in memory addresses 80 and 22 of the memory 140. It is to be understood that, in this embodiment, input data Data0 is first sent, followed by the input data Data1, Data2 and so on. Moreover, the input data Data0 (Addr:80) and Data 1 (Addr:22) are discontinuous since they are being stored in different memory blocks. Contrarily, input data Data0 (Addr:80), Data2 (Addr:81), Data4 (Addr:82) and Data9 (Addr:83) are continuous since they are being stored in the same memory block. Similarly, input data Data3 (Addr:00), Data6 (Addr:01) and Data8 (Addr:02) are also continuous.

The address comparing unit 120 receives the data sent by the graphic engine 110, acquires address information from the received data and buffers the received data into a corresponding buffer in the buffering unit 130 based on the acquired address information. In this embodiment, data within the same memory block are grouped together and filled into the same buffer. In other words, memory addresses between two data filled in the same buffer are adjacent to each other. Note that the size of a memory block depends on the length of a buffer. A buffer is identified as being full when no more available space is available in the buffer, and identified as being empty when no data is buffered in the buffer. For example, a buffer is full for a buffer with a length of 4 when four data are filled into the buffer. When one buffer in the buffering unit 130 is full, the data filled in that buffer will be outputted so as to empty the buffer. The outputted data are then sent to the memory 140 utilizing a burst transfer. The burst transfer transmits the data one by one to the memory 140. Because data within the same buffer belongs to the same memory block, the data can be outputted/written together to the memory 140 with a single burst mode command, which has a start address and a burst length indicating how much data are to be outputted to the memory 140. Under a burst mode, data are sequentially stored/written to the memory 140 starting from the start address to the start address plus the burst length. For example, a burst mode command with a start address 80 and a burst length of 4 will direct four data to be written to addresses 80-83 of the memory 140.

The display engine 150 then reads out the newly updated data from the memory 140 and processes read data to perform a corresponding operation (e.g. drawing a line) to be displayed on the display unit 160 (such as a screen of a LCD).

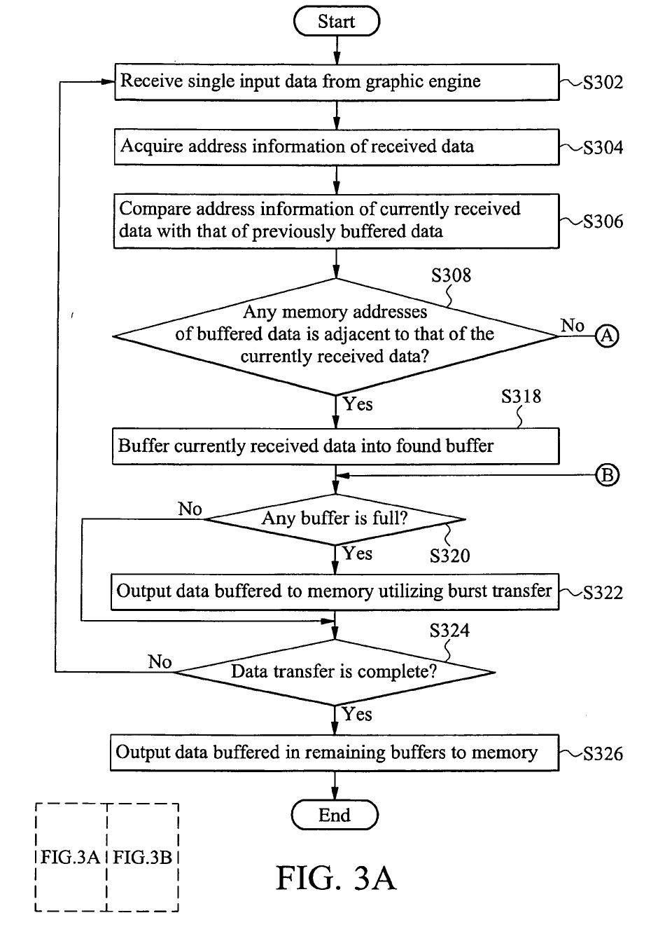

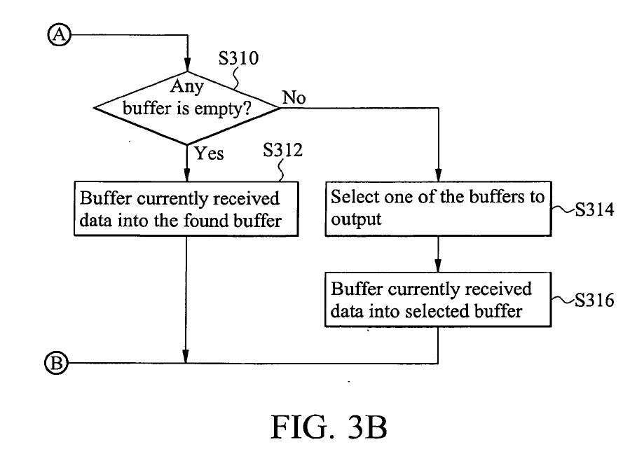

FIGS. 3A and 3B: show a flowchart of a data processing method for processing data sent from a graphic engine according to the invention in which steps S310-S316 are illustrated in FIG. 3B. Referring to FIGS. 1, 2, 3A and 3B, in step S302, input data from a graphic engine is received one by one. The data are inputted in an order from Data0 to Data10 (i.e. Data0->Data1-> . . . ->Data10). In step S304, address information of each of the received data is acquired from the received data. Next, in step S306, the address information of currently received data is compared with that of previously buffered data. In step S308, it is determined whether any memory addresses of the buffered data are adjacent to that of the currently received data. If so, step S318 is performed; if not, steps S310-S316 are further performed. If no adjacent memory address has been found among that of the buffer data, in step S310. the currently received data is required to be buffered in a free buffer that is empty. Therefore, it is determined whether any buffer is empty. If an empty buffer is found (Yes in step S310), in step S312, the currently received data is buffered into the found buffer. If all of the buffers are not empty (No in step S310), in step S314, one of the buffers is selected to output in order to buffer the currently received data. Note that the selecting of the buffer to be outputted may be randomly selected or selected by a specific rule, such as selecting the buffer with the most data to be outputted, for example. Then, in step S316, currently received data is buffered into the selected buffer. After step S312 or S316 has been performed, a later step S320 is further performed.

Contrarily, if an adjacent memory address has been found (Yes in step S308), in step S318, currently received data is buffered into the found buffer. The received data, therefore, will fill into the corresponding buffer one by one and received data being stored in the same memory block are buffered into the same buffer.

Thereafter, it is determined whether any buffer is full (step S320). If so (i.e. one of the buffers is full), in step S322, the buffered data are outputted to the memory 140 utilizing burst transfer by the aforementioned burst mode command. If no buffer is full (No in step S320), it is then checked whether data transfer has been completed (step S324). If the data transfer has been completed (Yes in step S324), data buffered in the remaining buffers other than the completely filled buffer are then outputted to the memory 140 (step S326). If the data transfer has not been completed yet (No in step S324), the process returns to step S302 for repeating the entire process.

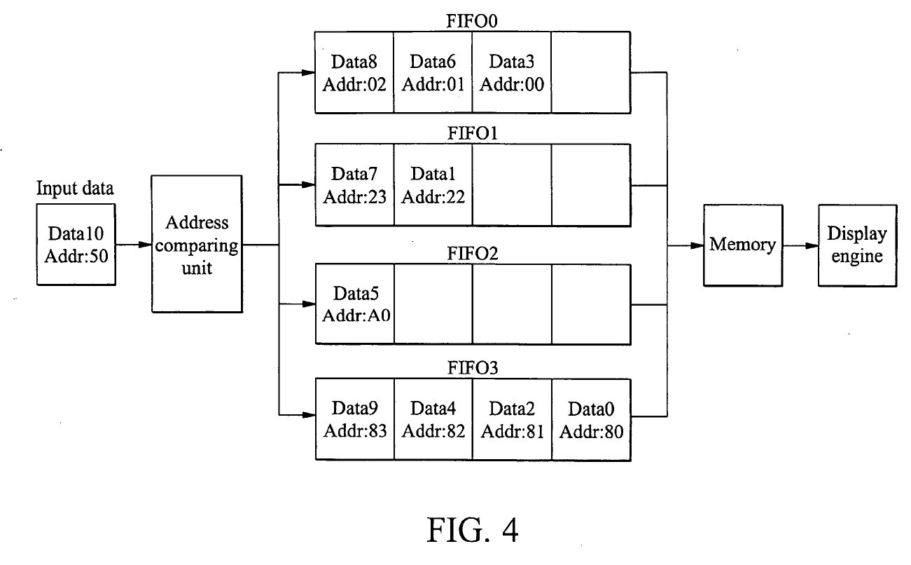

FIG. 4 is a schematic showing an embodiment of the method of FIG. 3 according to the invention. In this embodiment, it is assumed that the input data Data0-Data10 are the input data sequence 200 shown in FIG. 2. As shown in FIG. 4, four FIFO buffers FIFO0, FIFO1, FIFO2 and FIFO3 are utilized in the buffering unit for buffering the input data in which each buffer can buffer at most four input data. First, Data0 (Addr: 80) is received and buffered into buffer FIFO3. Next, Data1 (Addr:22) is received and buffered into another buffer FIFO1 due to Data1 being required to be stored in the memory block different from that of the Data0 (i.e. memory addresses of the Data1 and Data0 are not adjacent to each other). Then, Data2 is received and buffered into the buffer FIFO1 due to Data2 and Data0 being required to be stored in the same memory block (i.e. memory addresses of the Data1 and Data0 are adjacent to each other). Similarly, Data0, Data2, Data4 and Data 9 are buffered into the same buffer FIFO3; Data1 and Data 7 are buffered into the same buffer FIFO1; and Data3, Data6 and Data8 are buffered into the same buffer FIFO0 based on their corresponding address information for reason by analogy.

For the buffer FIFO3, all four data are filled and thus it is full. Therefore, data buffered in the buffer FIFO3 (i.e. Data0, Data2, Data4 and Data 9) will be outputted to the memory 140 with a one burst mode command with a start address 80 and a burst length of 4. After the data has been outputted, the buffer FIFO3 is empty thereby allowing subsequent received data Data10 to be filled in. After all of the input data has been received, the data transfer is completed and thus each data within the same buffer are outputted to the memory 140 with a corresponding burst mode command.

According to the invention, every single data from the graphic engine will be sent to an assigned buffer (e.g. FIFO) based on their address information by the address comparing unit. When one buffer is full, the data buffered will be outputted to the memory in a burst transfer. As shown in FIG. 4, compared with the conventional data transfer method needing four single transfers, one burst transfer required by the invention can save access time for the memory.

An advantage of the embodiment is that a simple address comparing unit and a buffering unit are used to buffer and collect data. Data with related addresses will be buffered together, then sent by burst transfer into a memory. This method, saves a lot of access time, improving memory efficiency.

While the invention has been described by way of examples and in terms of preferred embodiments, it is to be understood that the invention is not limited thereto. Any variation or modification can be made by those skilled in art without departing from the spirit or scope of the invention. Therefore, the scope of the appended claims should be accorded the broadest interpretation to encompass all such modifications and similar arrangements.

What is claimed is:

1. An image processing system, comprising:
a memory;
a graphic engine, generating a sequence of input data, wherein each of the input data has an address information pointing to a corresponding memory address of the memory; and
a data processing module, sequentially receiving the input data from the graphic engine, buffering each of the received data into a corresponding buffer according to the address information thereof, and outputting buffered data in a buffer to the memory when the buffer is full,
wherein memory addresses of the outputted data are continuous.

2. The image processing system as claimed in claim 1, wherein the data processing module further comprises:
a buffering unit having a plurality of buffers; and
a comparing unit, receiving the input data, comparing the address information of the received data and distributing the received data with the corresponding address information into the same buffer.

3. The image processing system as claimed in claim 2, wherein the comparing unit further outputs the buffered data in the buffer to the memory by utilizing a burst mode command.

4. The image processing system as claimed in claim 3, wherein the comparing unit further outputs buffered data in other buffers other than the completely filled buffer to the memory by utilizing corresponding burst mode commands after the data transfer has been completed.

5. The image processing system as claimed in claim 4, wherein the comparing unit selectively outputs data buffered in one of the buffers when the buffers are not empty and the address information of a subsequent received data is not continues to any of that in the buffers, and buffers the received data into the selected buffer.

6. The image processing system as claimed in claim 2, wherein the buffer is a first-in-first-out (FIFO) buffer.

7. The image processing system as claimed in claim 1, wherein the address information of the inputted data is discontinuous.

8. The image processing system as claimed in claim 1, wherein the received data is an image data or an on-screen display (OSD) data.

9. The image processing system as claimed in claim 1, further comprising a display engine and a display unit, wherein the display engine reads out the data newly updated from the memory and outputs the read data to be displayed on the display unit.

10. A data processing method for use in an image processing system, comprising:
sequentially receiving data, each having an address information pointing to a corresponding memory address of a memory, from a graphic engine;
buffering each of the received data into a corresponding buffer according to the address information thereof; and
outputting buffered data in a buffer to the memory when the buffer is full,
wherein memory addresses of the outputted data are continuous.

11. The data processing method as claimed in claim 10, wherein the address information of the received data is discontinuous.

12. The data processing method as claimed in claim 11, wherein the step of buffering each of the received data into the corresponding buffer according to the address information thereof further comprises:
comparing the address information of the received data; and
buffering the received data with the corresponding address information into the same buffer.

13. The data processing method as claimed in claim 10, wherein the step of outputting buffered data in the buffer to the memory is implemented by utilizing a burst mode command.

14. The data processing method as claimed in claim 10, wherein the received data is an image data or an on-screen display (OSD) data.

15. The data processing method as claimed in claim 10, further comprising:
providing a plurality of buffers;
buffering each of the received data into the corresponding buffer according to the address information thereof,
outputting buffered data in a buffer to the memory by a burst mode command when the buffer is full; and
outputting buffered data in other buffers other than the completely filled buffer to the memory by corresponding burst mode commands after the data transfer has been completed.

16. The data processing method as claimed in claim 15, further comprising:
receiving a first data;
selectively outputting data buffered in one of the buffers when the buffers are not empty and the address information of the first data is not continues to any of that in the buffers; and
buffering the first data into the selected buffer.

17. A data processing method for use in an image processing system, wherein the image processing system comprises a graphic engine, a plurality of buffers and a memory, comprising:
sequentially receiving data, each having an address information pointing to a corresponding memory address of the memory, from the graphic engine;
buffering each of the received data into a corresponding buffer according to the address information thereof, wherein the address information of currently received data is compared with that of previously buffered data and currently received data is buffered in a buffer of the buffered data, wherein the memory address is adjacent to that of the currently received data;
outputting buffered data in a buffer to the memory when the buffer is full; and
outputting buffered data in other buffers other than the completely filled buffer to the memory after the data transfer has been completed,
wherein memory addresses of the outputted data are continuous.

18. The data processing method as claimed in claim 17, wherein the step of buffering each of the received data into the corresponding buffer according to the address information thereof further comprises:
comparing the address information of currently received data with that of previously buffered data;
selectively outputting data buffered in one of the buffers when the buffers are not empty and there is no buffer with buffered data with a memory address adjacent to that of the currently received data; and
buffering the currently received data into the selected buffer.

19. The data processing method as claimed in claim 17, wherein the step of outputting buffered data is implemented by utilizing a corresponding burst mode command.

20. The data processing method as claimed in claim 17, wherein the received data is an image data or an on-screen display (OSD) data.
